(19) United States
(12) Patent Application Publication
(10) Pub. No.: US 2021/0164822 A1
(43) Pub. Date: Jun. 3, 2021

(54) CORIOLIS MEASURING SENSOR AND CORIOLIS MEASURING DEVICE

(71) Applicant: Endress+Hauser Flowtec AG, Reinach (CH)

(72) Inventors: Hao ZHU, Freising (DE); Martin Josef ANKLIN, Dornach (CH); Ennio BITTO, Aesch (CH)

(21) Appl. No.: 17/052,423

(22) PCT Filed: Apr. 17, 2019
(86) PCT No.: PCT/EP2019/059950

§ 371 Date: Nov. 2, 2020

(30) Foreign Application Priority Data
May 2, 2018 (DE) 10 2018 110 495.2

(51) Int. Cl. G01F 1/84; G01N 9/00

(52) U.S. Cl. CPC G01F 1/8477; G01F 1/8422; G01N 2009/006; G01N 9/002; G01F 1/8427

(57) ABSTRACT

The invention relates to a Coriolis measuring transducer (10), comprising:

at least one measuring tube;

at least one exciter mechanism (12.1);

at least two sensor groups of sensor arrangements with, in each case, at least one sensor arrangement,

wherein the at least one measuring tube is at least sectionally bent,

wherein the measuring tube is clamped in the regions of the inlet and the outlet by, in each case, a securement apparatus,

wherein the measuring tube has an inner side (IS) facing a longitudinal axis as well as an outer side (OS) facing away from the longitudinal axis,

wherein the exciter mechanism is arranged in a midlength region of the measuring tube, wherein a first sensor group is arranged in an inlet side intermediate region of the measuring tube, and wherein a second sensor group is arranged in an outlet side intermediate region of the measuring tube,

wherein at least one sensor group (13) is a supplemented sensor group (13.1) and includes at least two sensor arrangements (13.2).

The invention relates to a Coriolis measuring transducer and to a Coriolis measuring device having a temperature measuring device integrated in a sensor or in an exciter.

Coriolis measuring devices utilize the fact that an oscillation imposed on a measuring tube is modified in a characteristic manner as a function of a flow of a medium through the measuring tube as compared with an oscillation without flow. The imposing and registering of these oscillations is accomplished by means of exciters and sensors, respectively. Usually in such case, the measuring tube is excited to oscillate in an oscillation fundamental mode, wherein the flow causes a deflection in a higher oscillatory mode.

Coriolis measuring devices exist in various embodiments. Thus, the following documents show Coriolis measuring devices with two equally embodied measuring tubes, wherein EP2271899B1 discloses a Coriolis measuring device with two straight measuring tubes and DE102016112600A1 a Coriolis measuring device with two bent measuring tubes.

In the case of high pressure applications, it is necessary that tubes carrying media have a sufficient strength, this being assured by means of appropriate thickness of the tubes. This has in the case of Coriolis measuring devices, however, the disadvantage that the oscillation amplitude of oscillations of a measuring tube is reduced and, thus, signal/noise ratio decreases.

As object of the invention is, consequently, to provide a Coriolis measuring transducer as well as a Coriolis measuring device, which are suitable for high pressure applications.

The object is achieved by a Coriolis measuring transducer as defined in independent claim 1 as well as by a Coriolis measuring device as defined in independent claim 14.

A Coriolis measuring transducer of the invention for a Coriolis measuring device for registering a mass flow or a density of a medium flowing through at least one measuring tube of the Coriolis measuring device comprises:

the at least one measuring tube having an inlet and an outlet and adapted to guide the medium between the inlet and the outlet;

at least one exciter mechanism, which is adapted to excite the at least one measuring tube to execute oscillations in an f1 mode;

at least two sensor groups of sensor arrangements with, in each case, at least one sensor arrangement, wherein the sensor arrangements are adapted to register deflection of the oscillations of the at least one measuring tube;

wherein the at least one measuring tube is at least sectionally bent and defines a measuring tube longitudinal plane as well as a measuring tube path along a measuring tube centerline,

wherein the exciter mechanism is adapted to excite oscillations perpendicularly to the measuring tube longitudinal plane,

wherein the measuring tube is clamped in the regions of the inlet and the outlet by, in each case, a securement apparatus in such a manner that measuring tube oscillations have, in the regions of the inlet and outlet, outer oscillation nodes, which define node points on the measuring tube centerline, wherein the node points define a longitudinal axis,

wherein the measuring tube has an inner side facing the longitudinal axis as well as an outer side facing away from the longitudinal axis,

wherein the exciter mechanism is arranged relative to the inlet and the outlet in a midlength region of the measuring tube, wherein a first sensor group is arranged in an inlet side intermediate region of the measuring tube, and wherein a second sensor group is arranged in an outlet side intermediate region of the measuring tube,

wherein at least one sensor group is a supplemented sensor group and includes at least two sensor arrangements,

wherein each sensor arrangement of the supplemented sensor group is arranged on an outer side or on an inner side of the measuring tube,

wherein a sensor arrangement on the outer side is an outer sensor arrangement, and wherein a sensor arrangement on the inner side is an inner sensor arrangement.

The f1 mode is the oscillation fundamental mode, which is mirror symmetric relative to a measuring tube cross sectional plane intersecting the measuring tube at midlength. The provision of at least one supplemented sensor group having at least two sensor arrangements enables a better signal/noise ratio for flow and/or density measurement.

In an embodiment, the sensor arrangements of the supplemented sensor group are arranged either on the outer side or on the inner side, wherein a first sensor arrangement is arranged in a first cross section of the measuring tube centerline, and wherein a second sensor arrangement is arranged in a second cross section of the measuring tube centerline, wherein the first sensor arrangement is offset relative to the second sensor arrangement toward the exciter mechanism along the measuring tube centerline by a first offset length.

The offset of the sensor arrangements along the measuring tube centerline prevents that the individual sensor arrangements, or electrical connections of the sensor arrangements with an electronic measuring/operating circuit, for example, mechanically influence one another.

In an embodiment, the measuring tube is adapted in the case of flow of a medium to establish an f2 mode, wherein the f2 mode has an inner oscillation node (ION) as well as between inner oscillation node and the outer oscillation nodes, in each case, an f2 amplitude maximum, wherein the second sensor arrangement is arranged in a region of an f2 amplitude maximum, and wherein the first sensor arrangement is arranged in a region of a maximum ratio of f2 amplitude to f1 amplitude.

In the region of the f2 amplitude maximum, a good signal/noise ratio can be found, and in the region of maximum ratio, f2 amplitude to f1 amplitude, there is a maximum delay between an inlet side, first sensor arrangement and an outlet side, first sensor arrangement.

In an embodiment, a first sensor arrangement is arranged on the outer side and a second sensor arrangement is arranged on the inner side.

An addition of the sensor signal of the inner sensor arrangement and a sensor signal of the outer sensor arrangement leads to an at least partial canceling of an influence of a measuring tube torsion on the sensor signal. In this way, an improved determining of a mass flow and/or density measured value can be obtained.

In an embodiment, the inner sensor arrangement is offset relative to the outer sensor arrangement toward the exciter mechanism along the measuring tube centerline by a second offset length (OL2),

wherein the inner sensor arrangement experiences a torsion amplitude of the measuring tube, which differs by less than 20% and, especially, less than 10% from the torsion amplitude of the measuring tube at the outer sensor arrangement.

Thus, the influence of the measuring tube torsion on the mass flow and/or density measurement can be further lessened.

In an embodiment, the measuring transducer has an even number of measuring tubes, wherein, in each case, two measuring tubes form a measuring tube pair, wherein the measuring tubes of a measuring tube pair are adapted to oscillate oppositely from one another,

wherein the measuring tubes of a measuring tube pair are embodied as mirror images relative to a mirror plane arranged between the corresponding measuring tube longitudinal planes.

In an embodiment, the securement apparatus is adapted to couple the measuring tubes of at least one measuring tube pair with one another,

wherein the securement apparatus has a first clamping apparatus to establish the oscillation nodes in the inlet and outlet regions, and wherein the securement apparatus has on an exciter mechanism far side of the first clamping apparatus at least a second clamping apparatus for suppressing a measuring tube oscillation at an exciter mechanism far side of the first clamping apparatus.

In an embodiment, the first clamping apparatus and/or the second clamping apparatus are/is plate shaped and at least partially surround(s) the measuring tubes of a measuring tube pair.

In an embodiment, the measuring transducer is adapted for high pressure applications,

wherein a ratio of outer diameter of the measuring tube to thickness is at most 20 and, especially, at most 17 and preferably at most 15, and/or wherein

a minimum pressure is 40 bar and, especially, 70 bar and preferably 100 bar.

In an embodiment, the measuring transducer includes two manifolds, wherein a first manifold is adapted on an upstream side of the measuring transducer to receive a medium coming from a pipeline into the measuring transducer and to lead the medium to the inlet of the at least one measuring tube,

wherein a second manifold is adapted to receive the medium coming from the outlet of the at least one measuring tube and to lead the medium back into the pipeline.

In an embodiment, the measuring transducer includes two process connections, especially flanges, which are adapted to connect the measuring transducer into a pipeline.

In an embodiment, the measuring transducer includes a support tube having a support tube chamber, which is adapted to house the at least one measuring tube at least sectionally.

In an embodiment, the exciter mechanism includes at least one movable exciter element and at least one stationary exciter element, wherein the movable exciter element is arranged at a measuring tube, and/or

wherein the sensor arrangement has at least one movable sensor element and at least one stationary sensor element, wherein the movable sensor element is arranged at a measuring tube and is adapted to follow movements of the measuring tube,

wherein the stationary exciter-, or sensor, element is especially a coil apparatus, and wherein the movable exciter-, or sensor, element is especially a permanent magnet.

A Coriolis measuring device of the invention comprises: a Coriolis measuring transducer as claimed in one of the preceding claims;

an electronic measuring/operating circuit, which is adapted to operate the exciter mechanism as well as the sensor arrangements,

wherein the electronic measuring/operating circuit is further adapted, based on oscillation characteristics of the measuring tube measured by means of the sensor arrangements, to ascertain flow measured values and/or density measurement values, and

wherein the electronic measuring/operating circuit is connected by means of electrical connections with the sensor arrangements as well as with the exciter mechanism,

wherein the measuring device has especially an electronics housing for housing the electronic measuring/operating circuit.

The invention will now be described based on examples of embodiments presented in the appended drawing, the figures of which show as follows:

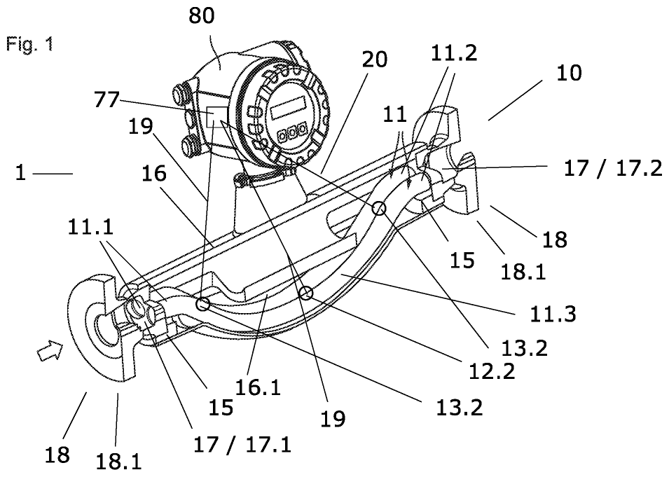

FIG. 1 construction of a typical Coriolis measuring device;

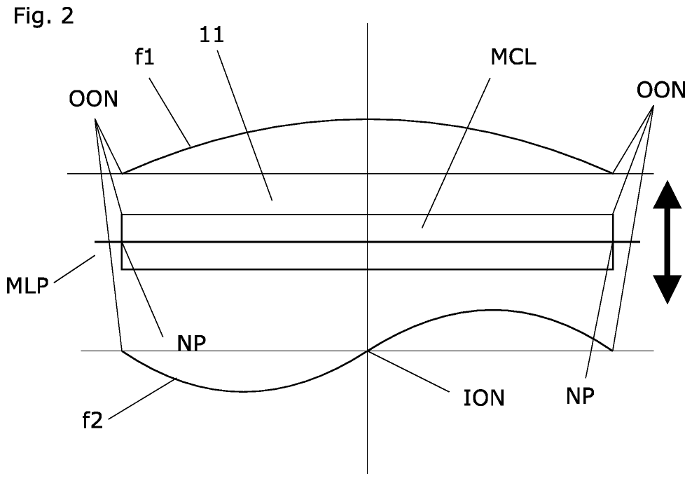

FIG. 2 schematically, measuring tube oscillation modes and positions of characteristic points, lines and planes;

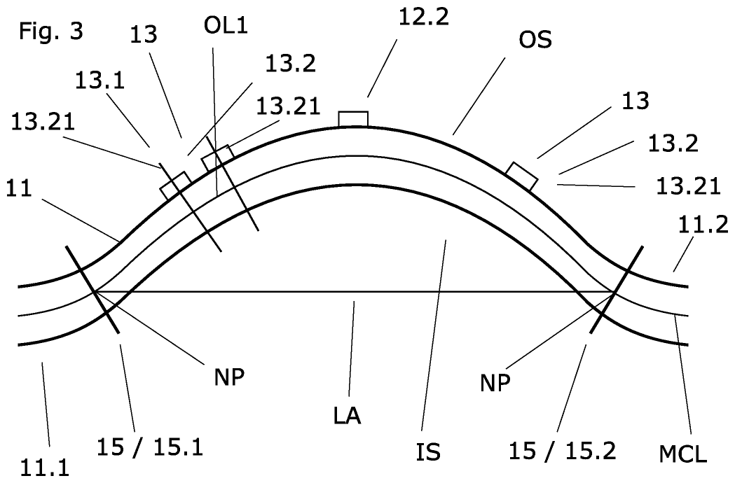

FIG. 3 schematically, a measuring tube with an example of a sensor arrangement of the invention; and

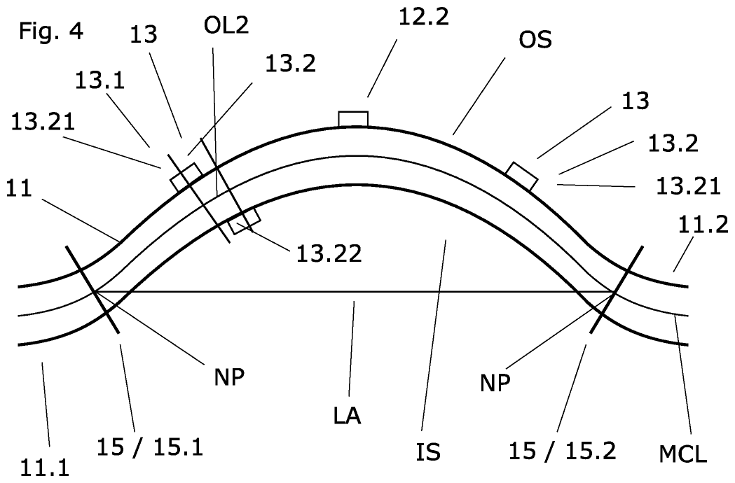

FIG. 4 schematically, a measuring tube with an example of a sensor arrangement of the invention.

FIG. 1 shows the construction of a Coriolis measuring device 1 having a Coriolis measuring transducer 10, wherein the measuring transducer has two measuring tubes 11 with, in each case, an inlet 11.1 and an outlet 11.2, an exciter mechanism 12.2, two sensor arrangements 13.2, two manifolds 17 and two process connections 18. The exciter mechanism is adapted to excite the two measuring tubes to oscillate perpendicularly to measuring tube longitudinal planes defined by the bent measuring tubes. The sensor arrangements are adapted to register oscillations imposed on the measuring tubes. A first manifold 17.1 on an upstream side of the measuring transducer is adapted to receive a medium coming from a pipeline into the measuring transducer and to lead the medium to the inlets of the two measuring tubes, and a second manifold 17.2 is adapted to receive the medium coming from the outlets of the two measuring tubes and to lead the medium back into the pipeline. The manifolds communicate with process connections 18, which, such as shown here, can be flanges 18.1. The process connections are adapted to connect the Coriolis measuring transducer, and the Coriolis measuring device, into a pipeline.

The Coriolis measuring transducer is connected with an electronics housing 80 of the Coriolis measuring device, which is adapted to house an electronic measuring/operating circuit 77, which is adapted to operate the exciter mechanism as well as the sensor arrangements and based on oscillation characteristics of the measuring tube measured by means of the sensor arrangements to ascertain and to provide flow measured values and/or density measurement values. The exciter mechanism as well as the sensor arrangements are connected by means of electrical connections 19 with the electronic measuring/operating circuit. The electrical connections 19 can be brought together by cable guides.

The Coriolis measuring transducer includes, furthermore, securement apparatuses 15, which are adapted to define outer oscillation nodes of measuring tube oscillations.

A Coriolis measuring device of the invention is not limited to two measuring tubes. Thus, also single tube- or measuring tube systems with more than two tubes can be used.

FIG. 2 shows a schematic, plan view of a measuring tube 11 along an associated measuring tube longitudinal plane MLP. Oscillations imposed by an exciter mechanism on the measuring tube have oscillation amplitudes extending perpendicularly to the measuring tube longitudinal plane, such as indicated by the double arrow. An f1 mode is mirror symmetrical relative to a measuring tube cross sectional plane intersecting the measuring tube at midlength, while an f2 mode is, in such case, an oscillatory mode of second order, wherein an amplitude distribution along the measuring tube centerline is point-symmetric relative to an intersection of the measuring tube cross sectional plane with the measuring tube centerline.

The f1 mode includes, in such case, an amplitude distribution having a maximum, which maximum lies at midlength between the outer oscillation nodes OON. The f2 mode includes at midlength between the outer oscillation nodes an inner oscillation node ION, wherein extremes of the amplitude distribution are present between the inner oscillation node and each outer oscillation node.

FIG. 3 shows schematically a measuring tube 11 with an example of a sensor group 13 of the invention. The measuring tube is clamped by means of a securement apparatus 15, so that on a measuring tube centerline MCL node points NP are defined, where the measuring tube oscillations have outer node points. The securement apparatus includes inlet side a first clamping apparatus 15.1 and outlet side a second clamping apparatus 15.2. First clamping apparatus 15.1 and second clamping apparatus 15.2 can be embodied plate shaped, for example.

The node points NP define a longitudinal axis LA, relative to which the measuring tube has between the node points an inner side IS as well as an outer side OS. The exciter mechanism 12.2 is arranged at midlength on the outer side of the measuring tube. It can, however, also be arranged on the inner side of the measuring tube. Arranged between the exciter mechanism and the clamping apparatuses 15.1, 15.2 is, in each case, a sensor group 13 having at least one sensor arrangement 13.2. According to the invention, at least one sensor group is a supplemented sensor group 13.1 having at least two sensor arrangements 13.2, wherein two outer sensor arrangements 13.21 are arranged on the outer side of the measuring tube and are offset from one another by an offset length OL1 along the measuring tube centerline MCL. Alternatively, the sensor arrangements can also be arranged on the inner side of the measuring tube. By way of example, the second sensor arrangement is arranged in a region of the f2 amplitude maximum, and the first sensor arrangement is arranged in a region of a maximum ratio, f2 amplitude to f1 amplitude.

FIG. 4 shows schematically a measuring tube 11 with an example of a sensor group 13 of the invention. Other than shown in FIG. 3, a supplemented sensor group of the invention in this case has one inner sensor arrangement and one outer sensor arrangement, which are preferably offset from one another by an offset length OL2 along the measuring tube centerline MCL. By providing an outer sensor arrangement and an inner sensor arrangement, a measuring tube torsion can be at least partially compensated. By using the offset length OL2, it can be assured that the torsion amplitudes of the sensor arrangements differ by less than 20% from one another. The second offset length can have, for example, a value of 0.5 to 2 measuring tube diameters.

### LIST OF REFERENCE CHARACTERS

1 Coriolis measuring device

10 Coriolis measuring transducer

11 measuring tube

11.1 inlet

11.2 outlet

11.3 bend

12.2 exciter mechanism

13 sensor group

13.1 supplemented sensor group

13.2 sensor arrangement

13.21 outer sensor arrangement

13.22 inner sensor arrangement

15 securement apparatus

15.1 clamping apparatus

16 support tube

16.1 support tube chamber

17 manifold

17.1 first manifold

17.2 second manifold

18 process connection

18.1 flange

19 electrical connections

20 cable path

77 electronic measuring/operating circuit

80 electronics housing

MCL measuring tube centerline

MLP measuring tube longitudinal plane

OON outer oscillation nodes

ION inner oscillation nodes

LA longitudinal axis

Q1 first cross section

Q2 second cross section

OL1 first offset length

OL2 second offset length

1-14. (canceled)

15. A Coriolis measuring transducer of a Coriolis measuring device for registering a mass flow or a density of a medium flowing through at least one measuring tube of the Coriolis measuring device, the measuring transducer comprising:
the at least one measuring tube having an inlet and an outlet and adapted to guide the medium between the inlet and the outlet, wherein the at least one measuring tube is at least sectionally bent and defines a measuring tube longitudinal plane and a measuring tube path along a measuring tube centerline;
an exciter mechanism adapted to excite the at least one measuring tube to execute oscillations in an f1 mode, wherein the exciter mechanism is configured to excite the oscillations perpendicular to the measuring tube longitudinal plane;
at least two sensor groups of sensor arrangements, each including at least one sensor arrangement, wherein the sensor arrangements are configured to detect deflections of the oscillations of the at least one measuring tube,
wherein the at least one measuring tube is fixed at or near the inlet and the outlet by, in each case, a securement apparatus such that the oscillations have, at or about the inlet and outlet, outer oscillation nodes which define node points on the measuring tube centerline, wherein the node points define a longitudinal axis,
wherein the measuring tube has an inner side adjacent the longitudinal axis and an outer side opposite the longitudinal axis,
wherein the exciter mechanism is disposed relative to the inlet and the outlet in a midlength region of the measuring tube, wherein a first sensor group of the at least two sensor groups is disposed in an inlet side intermediate region of the measuring tube, and wherein a second sensor group is disposed in an outlet side intermediate region of the measuring tube,
wherein at least one sensor group is a supplemented sensor group and includes at least two sensor arrangements, wherein each sensor arrangement of the supplemented sensor group is disposed on an outer side or on an inner side of the measuring tube,
wherein a sensor arrangement on the outer side is an outer sensor arrangement, and wherein a sensor arrangement on the inner side is an inner sensor arrangement.

16. The measuring transducer of claim 15, wherein the sensor arrangements of the supplemented sensor group are disposed either on the outer side or on the inner side, wherein a first sensor arrangement is disposed in a first cross-section of the measuring tube centerline, and wherein a second sensor arrangement is disposed in a second cross-section of the measuring tube centerline, wherein the first sensor arrangement is offset relative to the second sensor arrangement toward the exciter mechanism along the measuring tube centerline by a first offset length.

17. The measuring transducer of claim 16, wherein the measuring tube is configured to establish an f2 mode in operation, wherein the f2 mode has an inner oscillation node and an f2 amplitude maximum between inner oscillation node and the outer oscillation nodes, respectively,
wherein the second sensor arrangement is disposed in a region of an f2 amplitude maximum, and wherein the first sensor arrangement is disposed in a region of a maximum ratio of an f2 amplitude to an f1 amplitude.

18. The measuring transducer of claim 15, wherein a first sensor arrangement is disposed on the outer side and a second sensor arrangement is arranged on the inner side.

19. The measuring transducer of claim 18, wherein the inner sensor arrangement is offset relative to the outer sensor arrangement toward the exciter mechanism along the measuring tube centerline by a second offset length, and wherein the inner sensor arrangement experiences a torsion amplitude of the measuring tube, which differs by less than 20% from the torsion amplitude of the measuring tube at the outer sensor arrangement.

20. The measuring transducer of claim 15, wherein the measuring transducer includes an even number of measuring tubes, wherein, in each case, two measuring tubes form a measuring tube pair, wherein the measuring tubes of a measuring tube pair are configured to oscillate oppositely from one another, and wherein the measuring tubes of a measuring tube pair are embodied as mirror images relative to a mirror plane arranged between the corresponding measuring tube longitudinal planes.

21. The measuring transducer of claim 20, wherein each securement apparatus is configured to couple the measuring tubes of at least one measuring tube pair with one another, wherein each securement apparatus includes a first clamping apparatus configured to establish the outer oscillation nodes at or about the inlet and outlet, and
wherein each securement apparatus includes on a side of the first clamping apparatus opposite the exciter mechanism at least a second clamping apparatus configured to suppress measuring tube oscillations at the side of the first clamping apparatus opposite the exciter mechanism.

22. The measuring transducer of claim 21, wherein the first clamping apparatus and/or the second clamping apparatus are plate shaped and at least partially surround the measuring tubes of a measuring tube pair.

23. The measuring transducer of claim 15, wherein the measuring transducer is configured for high pressure applications, wherein a ratio of an outer diameter of the at least one measuring tube to its thickness is at most 20 and/or wherein a minimum pressure within the at least one measuring tube in operation is 40 bar.

24. The measuring transducer of claim 15, further comprising two manifolds, wherein a first manifold on an upstream side of the measuring transducer is adapted to receive the medium coming from a pipeline into the measuring transducer and to convey the medium to the inlet of the at least one measuring tube, and
wherein a second manifold is adapted to receive the medium from the outlet of the at least one measuring tube and to return the medium into the pipeline.

25. The measuring transducer of claim 15, further comprising two process connections, which are configured to connect the measuring transducer into a pipeline.

26. The measuring transducer of claim 15, further comprising a support tube having a support tube chamber configured to house the at least one measuring tube at least sectionally.

27. The measuring transducer of claim 15, wherein the exciter mechanism includes at least one movable exciter element and at least one stationary exciter element, wherein the movable exciter element is arranged at the at least one measuring tube, and/or
wherein the at least one sensor arrangement includes at least one movable sensor element and at least one stationary sensor element, wherein the movable sensor element is arranged at the at least one measuring tube and is configured to follow movements of the measuring tube,
wherein the at least one stationary exciter element or the at least one stationary sensor element is a coil apparatus, and wherein the at least one movable exciter element or the at least one movable sensor element is a permanent magnet.

28. A Coriolis measuring device, comprising:
a Coriolis measuring transducer according to claim 15;
an electronic measuring/operating circuit configured to operate the exciter mechanism and the sensor arrangements and, based on oscillation characteristics of the at least one measuring tube measured using the sensor arrangements, to ascertain flow measured values and/or density measurement values of the medium, and wherein the electronic measuring/operating circuit is connected via electrical connections with the sensor arrangements and the exciter mechanism; and
a housing configured to house the electronic measuring/operating circuit.
